(19) United States
(12) Patent Application Publication
(10) Pub. No.: US 2026/0009406 A1
(43) Pub. Date: Jan. 8, 2026

(54) MECHANICAL ACCUMULATOR FOR A BOILER OF A BEVERAGE DISPENSING MACHINE

(71) Applicant: Starbucks Corporation, Seattle, WA (US)

(72) Inventors: Joseph E. Gormley, Mercer Island, WA (US); Nathan C. Oren, Edgewood, WA (US)

(21) Appl. No.: 19/250,799

(22) Filed: Jun. 26, 2025

Related U.S. Application Data
(60) Provisional application No. 63/667,079, filed on Jul. 2, 2024.

(51) Int. Cl. F15B 1/02; A47J 31/46; A47J 31/54

(52) U.S. Cl. CPC F15B 1/02; A47J 31/461; A47J 31/468; A47J 31/54

(57) ABSTRACT

A mechanical accumulator may be an expansion tank for a boiler, such as a boiler for a beverage dispensing machine. The mechanical accumulator may include a housing with an inner volume. The accumulator may include a barrier positioned in the inner volume and configured to translate through the inner volume. The accumulator may include a spring positioned in the inner volume and coupled to the barrier. When a force is applied to the barrier by a fluid in a first portion of the inner volume, the spring can expand and/or contract to modify a volume of the first portion of the inner volume in order to regulate a pressure of the fluid in the first portion of the inner volume.

### CROSS-REFERENCE TO RELATED APPLICATIONS

The present application claims priority benefit to U.S. Provisional Patent Application Ser. No. 63/667,079, filed Jul. 2, 2024, the entirety of which is hereby incorporated by reference.

### FIELD

The present disclosure relates to mechanical accumulators, such as, in certain embodiments, mechanical accumulators configured to be used as an expansion chamber for a boiler of a beverage dispensing machine.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some embodiments, a beverage dispensing machine may include a brew chamber; a boiler configured to provide heated, pressurized water to the brew chamber; and an accumulator including: a housing with an inner volume; a bladder positioned in the inner volume, wherein the bladder forms a barrier between a first portion of the inner volume and a second portion of the inner volume; a support positioned in the second portion of the inner volume, wherein the bladder is positioned over the support; and a spring positioned in the second portion of the inner volume, wherein when a force is applied to the bladder by a fluid in the first portion of the inner volume, the spring expands and/or contracts in order to translate the support through the inner volume, and wherein the bladder is configured to expand and/or contract to modify a volume of the first portion of the inner volume when the support translates through the inner volume in order to regulate a pressure of the fluid in the boiler.

In some embodiments, the bladder may include an elastic material.

In some embodiments, the support may extend between a first end and a second end, and wherein the bladder is positioned over the first end of the support.

In some embodiments, the first end of the support may be rounded.

In some embodiments, the support may include a recess extending into the support from a second end.

In some embodiments, the spring may be coupled to a protrusion in the recess of the support.

In some embodiments, the housing may include a base portion and a cover portion, and a portion of the bladder may be positioned in a gap between the base portion and the cover portion to form a seal between the base portion and the cover portion.

In some embodiments, a beverage dispensing machine may include a brew chamber; a boiler configured to provide heated, pressurized water to the brew chamber; and an accumulator including: a housing with an inner volume; a piston positioned in the inner volume, the piston forms a barrier between a first portion of the inner volume and a second portion of the inner volume; and a spring positioned in the second portion of the inner volume, when a force is applied to the piston by a fluid in the first portion of the inner volume, the spring expands and/or contracts into order to translate the piston through the inner volume to modify a volume of the first portion of the inner volume and regulate a pressure of the fluid in the first portion of the inner volume.

In some embodiments, the piston may extend between a first end and a second end, and the first end of the piston may face the first portion of the inner volume.

In some embodiments, the piston may include a first recess extending into the piston from the first end of the piston.

In some embodiments, the piston may include a second recess extending into the piston from the second end of the piston.

In some embodiments, the spring may be coupled to a protrusion in the second recess of the piston.

In some embodiments, the accumulator may include one or more seals positioned around the piston in a gap between the piston and the housing.

In some embodiments, an accumulator for a beverage dispensing machine may include a housing with an inner volume; a barrier positioned in the inner volume and configured to translate through the inner volume; and a spring positioned in the inner volume and coupled to the barrier, when a force is applied to the barrier by a fluid in a first portion of the inner volume, the spring expands and/or contracts to modify a volume of the first portion of the inner volume in order to regulate a pressure of the fluid in the first portion of the inner volume.

In some embodiments, the barrier may include a bladder and a support, wherein the support is configured to translate through the inner volume to expand and/or contract the bladder.

In some embodiments, the barrier may include a piston.

In some embodiments, the housing may include a base portion and a cover portion, the base portion and the cover portion may be configured to removably coupled together to form the housing.

In some embodiments, the housing may include a fluid valve.

In some embodiments, the first portion of the inner volume may be between a first end of the housing and the barrier, and the spring may be positioned in a second portion of the inner volume between the barrier and a second end of the housing.

In some embodiments, the accumulator may be configured to be an expansion chamber of a boiler system of the beverage dispensing machine.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A illustrates a cross-section of an accumulator with a gas charged bladder.

FIG. 1B illustrates a boiler with the accumulator of FIG. 1A used as an expansion chamber for the boiler.

FIG. 2A illustrates a perspective view of a mechanical accumulator.

FIG. 2B illustrates a cross-section of the mechanical accumulator of FIG. 2A.

FIG. 2C illustrates a cross-section of the mechanical accumulator of FIG. 2A showing a spring and a bladder in an inner volume of a housing of the mechanical accumulator.

FIG. 3A illustrates a perspective view of another mechanical accumulator.

FIG. 3B illustrates a cross-section of the mechanical accumulator of FIG. 3A.

FIG. 3C illustrates a cross-section of the mechanical accumulator of FIG. 3A showing a spring in an inner volume of a housing of the mechanical accumulator.

### DETAILED DESCRIPTION

Although several embodiments, examples, and illustrations are disclosed below, it will be understood by those of ordinary skill in the art that the system, methods, and devices described herein extend beyond the specifically disclosed embodiments, examples, and illustrations and includes other uses of the system, methods, and devices and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure can include several novel features and no single feature is solely responsible for its desirable attributes or is essential to practicing the system, methods, and devices herein described.

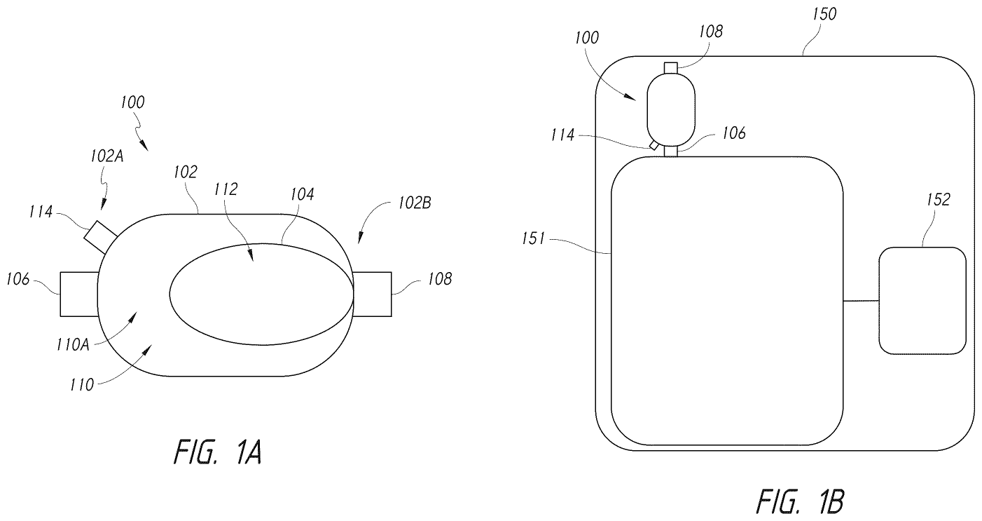

At high volume coffee stores, beverage dispensing machines (e.g., coffee machine, espresso machine, etc.) may prepare and dispense hundreds of beverages or beverage components a day. A coffee store may include multiple beverage dispensing machines in order prepare and dispense enough beverages or beverage components to keep up with customer orders. If one or more of the beverage dispensing machines malfunction, a maximum throughput of beverage or beverage components capable of being prepared and dispensed at a coffee store is significantly reduced. Not having a high enough throughput can lead to long lines and increased wait times for customers at the busiest times of the day, when customers are typically in a rush (i.e., commuting to work in the morning). In order to prepare beverage or beverage components, beverage dispensing machines provide pressurized, hot water to a brew chamber in the beverage dispensing machine, where the pressurized, hot water extracts flavors, aromas, or compounds from an extract in the brew chamber. Beverage dispensing machines heat water in a boiler, see FIG. 1B. When the boiler heats the water, the water may expand but the boiler typically has a fixed volume. Therefore, as the water expands, a pressure of the water may increase. After a portion of the heated water is transported from the boiler to a brew chamber, unheated water may be added to heated water remaining in the boiler. The water in the boiler may cool down and contract, and the pressure of the water in the boiler may decrease.

An expansion chamber may be connected to the boiler, as shown in FIG. 1B. The expansion chamber may allow water in the boiler to flow into the expansion chamber when the water expands in order to limit the increase of the pressure of the heated water in the boiler. As the water cools down and contracts, the water may flow out of the expansion chamber and back into the boiler.

If the water pressure in a beverage dispensing machine increases too much, the water pressure may damage pipes or other components of the beverage dispensing machine. If the water pressure in a beverage dispensing machine decreases too much, the water may not be able to pass through the brew chamber to prepare a beverage or beverage component.

In order to maintain or regulate the pressure of the water in the boiler, an accumulator may be used as an expansion chamber. An accumulator can include a housing with a bladder in the housing. The bladder can contract and expand to increase or decrease an inner volume of the housing, see FIG. 1A. The bladder may be pressurized so the bladder fills the inner volume of the housing. When the water in the boiler heats up and expands, pressurized water enters the housing and the bladder may contract to create more space for the pressurized water. This increases the effective volume to limit the increase in water pressure. When the pressure of the water decreases, or water exits the housing, the bladder may expand to take up space within the inner volume. Therefore, this decrease in volume can limit the decrease in pressure of the water.

By increasing and decreasing the volume for the water to flow through in the housing of the accumulator, the accumulator can maintain the pressure of the water in a beverage dispensing machine within a range of pressure the beverage dispensing machine is designed to operate at.

Typically, accumulators for beverage dispensing machines are charged with a gas, such as air. The bladder of the accumulator may be pressurized with the gas. The gas may be added to the bladder through a charging valve and the charging valve may be configured to maintain a pressure of the gas in the bladder. However, when the charging valve fails, the bladder may not be pressurized, the accumulator may not properly maintain a pressure of the water in accumulator, and the fluid may leak through a pressure relief valve of accumulator. Accordingly, the beverage dispensing machine will not be able to prepare beverages or beverage components. Therefore, the maximum throughput of beverage or beverage components capable of being prepared and dispensed at a coffee store will be reduced until a technician can repair the pressure relief valve.

In accordance with several embodiments, the systems and devices described herein advantageously maintain a pressure of the fluid in an accumulator mechanically. The accumulators include a spring configured to apply a force to a barrier in the accumulator. The spring may contract and/or expand in order to modify a volume of the accumulator and maintain a pressure of the fluid in the accumulator. The spring may fail less often than a charging valve, so the accumulator will not need to be serviced or repaired as frequently as a gas charged accumulator.

FIG. 1A shows a cross-sectional view of an embodiment of an accumulator 100 that is charged with a gas. The accumulator 100 may include a housing 102. The housing 102 may extend from a first end 102A to a second end 102B opposite the first end 102A. A fluid port 106 may be positioned at the first end 102A of the housing 102. A charging valve 108 may be positioned at the second end 102B of the housing 102. The housing 102 may include an inner volume 110. A bladder 104 may be positioned in the inner volume 110. The bladder 104 may be positioned so an inner volume 112 of the bladder 104 is in communication with the charging valve 108. The inner volume 112 of the bladder 104 may be filled with a gas via the charging valve 108 in order to pressurize the bladder 104. The gas may include air, nitrogen, and/or any other inert gas. The charging valve 108 may be configured to prevent or inhibit the gas from leaving the inner volume 112 of the bladder 104 through the charging valve 108. The charging valve 108 may maintain a pressure of the gas in the inner volume 112 of the bladder 104. The bladder 104 may include silicone and/or any other elastic material. The bladder 104 may include a food safe material. The bladder 104 may include a material configured to withstand high temperatures.

Fluid (e.g., water) may be enter the inner volume 110 of the housing 102 through the fluid port 106. The fluid may enter a portion 110A of the inner volume 110 not filled with the bladder 104. The fluid may enter the inner volume 110 when a pressure of the fluid is higher than a pressure of the gas in the inner volume 112 of the bladder 104. The pressure of the fluid may compress the gas in the inner volume 112 of the bladder 104. Accordingly, the bladder 104 may shrink or contract. The bladder 104 may shrink or contract until the pressure of the fluid in the inner volume 110 of the housing 102 is equal to the pressure of the gas in the inner volume 112 of the bladder 104. As the bladder 104 shrinks, a volume of the inner volume 112 of the bladder 104 may decrease. Therefore, a volume of the portion 110A of the inner volume 110 may increase. Accordingly, the pressure of the fluid in the portion 110A of the inner volume 110 may decrease and/or more fluid may enter into the portion 110A of the inner volume 110 through the fluid port 106.

The pressure of the fluid in the portion 110A of the inner volume 110 may decrease. As the pressure of the fluid decreases, the pressure of the gas in inner volume 112 of the bladder 104 may cause the bladder 104 to expand. The bladder 104 may expand until a pressure of the fluid in the portion 110A of the inner volume 110 is equal to the pressure of the gas in the inner volume 112 of the bladder 104 and/or all of the fluid in the portion 110A of the inner volume 110 exits the inner volume 110. As the bladder 104 expands, the bladder 104 may decrease the volume of the portion 110A of the inner volume 110. The bladder 104 may force the fluid out of the inner volume 110 through the fluid port 106.

The pressure of the gas in the inner volume 112 of the bladder 104 may be modified. Gas may be removed from the inner volume 112 of the bladder 104 through the charging valve 108 in order to decrease the pressure of the gas in the inner volume 112 of the bladder 104. Gas may be added into the inner volume 112 of the bladder 104 through the charging valve 108 in order to increase the pressure of the gas in the inner volume 112 of the bladder 104.

The accumulator 100 may include a pressure relief valve 114. The pressure relief valve 114 may allow fluid in the portion 110A of the inner volume 110 of the housing 102 to exit the housing 102 when a pressure of the fluid in the portion 110A of the inner volume 110 increases above a predetermined pressure threshold.

As shown in FIG. 1B, the accumulator 100 may be coupled to a boiler 151 of a beverage dispensing machine (e.g., a coffee or espresso machine) 150. The accumulator 100 may be an expansion tank for the boiler 151. The accumulator 100 may maintain or regulate a pressure of fluid (e.g., water) in the boiler 151 and/or the beverage dispensing machine 150. The boiler 151 may be configured to heat and/or pressurize the fluid in the boiler 151. The heated and/or pressurized fluid may be transported to a brew chamber 152 of the beverage dispensing machine 150 to prepare a beverage or beverage component in the brew chamber 152. As the temperature of the fluid increases, the fluid may expand and enter the accumulator 100. The fluid in the boiler 151 may cool down. Accordingly, the fluid may compress and exit the accumulator 100. The bladder 104 may expand and/or contract, as described with reference to FIG. 1A, in order to maintain or regulate the pressure of the fluid in the boiler 151 as the temperature of the fluid increases and/or decreases.

If the charging valve 108 malfunctions, the gas may leak out of the bladder 104 via the charging valve 108. Accordingly, the charging valve 108 may not be able to maintain the pressure in the bladder 104. Therefore, the bladder 104 may not properly expand and/or contract to maintain the pressure of the fluid in the boiler 151. Furthermore, the since the bladder 104 includes an elastic material and/or the accumulator 100 does not include any component that supports the bladder 104, the bladder 104 may deform and block the fluid port 106. The bladder 104 may prevent or inhibit fluid from entering and/or exiting the inner volume 110 of the housing 102 via the fluid port 106.

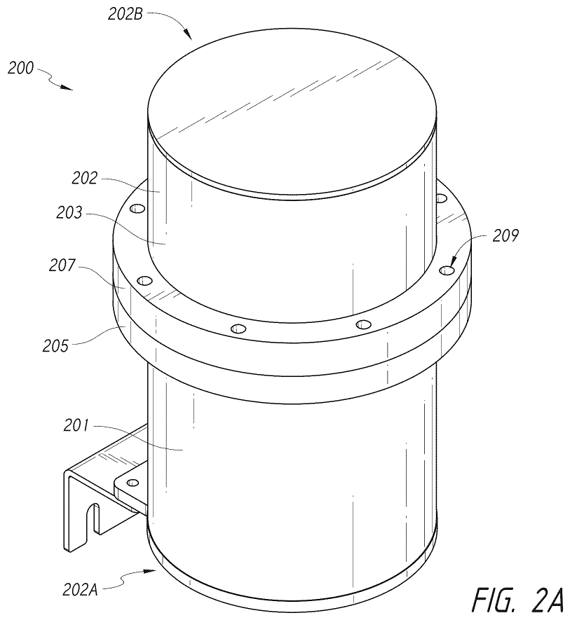

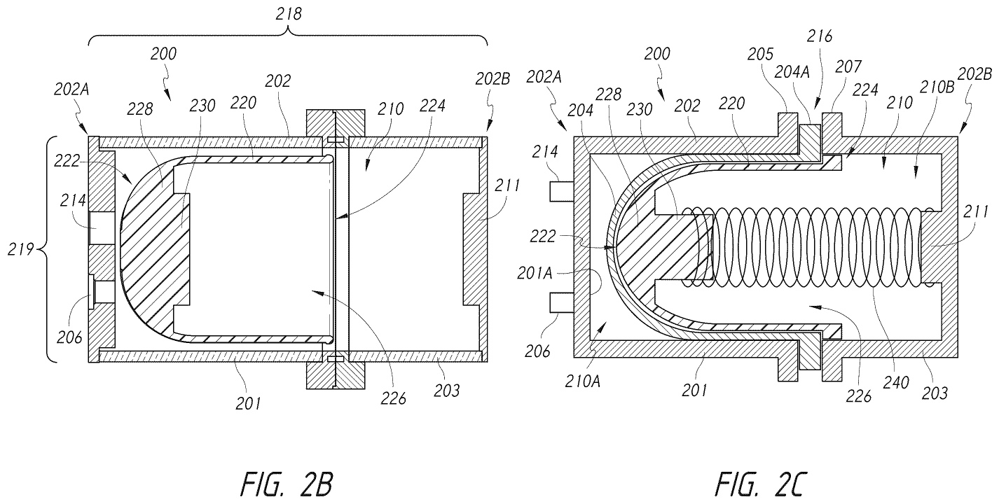

FIGS. 2A-2C show an embodiment of an accumulator 200 that can be used in connection with the system shown in FIG. 1B. The accumulator 200 may include a mechanical accumulator. As shown in FIG. 2C, the accumulator 200 may include a spring 240 that may translate a support 220 through an inner volume 210 of a housing 202 of the accumulator 200. Translation of the support 220 through the inner volume 210 may cause a bladder 204 to expand and/or contract instead of pressurized air like the accumulator 100. When the bladder 204 expands and/or contracts, a volume of a first portion 210A of the inner volume 310 may increase and/or decrease.

As shown in FIG. 2A, the accumulator 200 may include a housing 202. The housing 202 may extend from a first end 202A to a second end 202B opposite the first end 202A. The housing 202 may include a base portion 201 and a cover portion 203. The base portion 201 and the cover portion 203 may be coupled together to form the housing 202. The base portion 201 may extend from the first end 202A of the housing 202 to the cover portion 203. The cover portion 203 may extend from the second end 202B to the base portion 201. As shown in FIGS. 2B and 2C, the housing 202 may include a pressure relief valve 214. The pressure relief valve 214 may be positioned on the base portion 201 at the first end 202A of the housing 202.

As shown in FIG. 2A, the base portion 201 may include a flange 205 and the cover portion 203 may include a flange 207. The flange 205 may extend radially outward from an end of the base portion 201 opposite the first end 202A. The flange 207 may extend radially outward from an end of the cover portion 203 opposite the second end 202B. The flanges 205, 207 may include holes 209 extending through the flanges 205, 207. Mechanical fasteners (e.g., bolts, screws, etc.) may be inserted through the holes 209 to secure the flanges 205, 207 together and couple the base portion 201 to the cover portion 203.

The housing 202 may include a height 218 and a diameter 219, as shown in FIG. 2B. The height 218 of the housing 202 may include a distance of about 3.0 in, about 4.0 in, about 5.0 in, about 6 in, about 7.0 in, about 8.0 in, about 9.0 in, about 10.0 in, about 11.0 in, about 12.0 in, about 13.0 in, about 14.0 in, about 15.0 in, about 16.0 in, about 17.0 in, about 18.0 in, about 19.0 in, about 20.0 in, and/or any value between the aforementioned values. The diameter 219 of the housing 202 may include a distance of about 1.0 in, about 1.5 in, about 2.0 in, about 2.5 in, about 3.0 in, about 3.5 in, about 4.0 in, about 4.5 in, about 5.0 in, about 5.5 in, about 6.0 in, about 6.5 in, about 7.0 in, about 7.5 in, about 8.0 in, about 8.5 in, about 9.0 in, about 9.5 in, about 10.0 in, and/or any value between the aforementioned values.

As shown in FIGS. 2B and 2C, the support 220 may be positioned in the inner volume 210. The support 220 may be configured to translate through the inner volume 210 between the first end 202A of the housing 202 and the second end 202B of the housing 202. The support 220 may be positioned in the inner volume 210 so a first end 222 of the support 220 faces the first end 202A of the housing 202 and/or a second end 224 of the support 220 faces the second end 202B of the housing 202.

The support 220 may include a recess 226. The recess 226 may extend into the support 220 from the second end 224 of the support 220 to a base 228 of the recess 226. The support 220 may include a protrusion 230 positioned on the base 228. The protrusion 230 may extend from the base 228 of the recess 226 towards the second end 224 of the support 220.

As shown in FIG. 2C, the spring 240 may be positioned in the inner volume 210 of the housing 202. The spring 240 may be positioned between the support 220 and the second end 202B of the housing 202. The spring 240 may be coupled to the support 220. The spring 240 may extend into the recess 226 in the support 220. The spring 240 may be coupled to the protrusion 230.

As shown in FIGS. 2B and 2C, the cover portion 203 of the housing 202 may include a protrusion 211. The protrusion 211 may be positioned in the inner volume 210 of the housing 202. The protrusion 211 may extend from the cover portion 203 into the inner volume 210. The protrusion 211 may extend from the second end 202B of the housing 202. As shown in FIG. 2C, the spring 240 may be coupled to the protrusion 211.

With reference to FIG. 2C, when the support 220 translates towards the second end 202B of the housing 202 the spring 240 may compress. The spring 240 may apply a reaction force to the support 220 in a direction towards the first end 202A of the housing 202. The spring 240 may prevent or inhibit the support 220 from translating towards the second end 202B of the housing 202. When the support 220 translates towards the first end 202A of the housing 202, the spring 240 may elongate. The reaction force applied to the support 220 by the spring 240 in a direction towards the first end 202A of the housing 202 may decrease and/or the spring 240 may apply a reaction force to the support 220 in a direction towards the second end 202B of the housing 202. The spring 240 may prevent or inhibit the support 220 from translating towards the first end 202A of the housing 202. The spring 240 may be biased towards the first end 202A of the housing 202. Therefore, when no forces are applied to the support 220, the spring 240 may position the support 220 in the inner volume 210 at the first end 202A of the housing 202.

As shown in FIG. 2C, a bladder 204 may be positioned in the inner volume 210. The bladder 204 may include silicone and/or any other elastic material. The bladder 204 may include a food safe material. The bladder 204 may include a material configured to withstand high temperatures. The bladder 204 may be positioned over the first end 222 of the support 220. The bladder 204 may be positioned between the support 220 and the first end 202A of the housing 202.

The bladder 204 may extend into a gap 216 between the flange 205 of the base portion 201 and the flange 207 of the cover portion 203. When the flange 205 and the flange 207 are coupled together (e.g., via a mechanical fastener), the flange 205 and the flange 207 may apply a force to a portion 204A of the bladder 204 positioned in the gap 216. Friction between the flanges 205, 207 and the portion 204A of the bladder 204 may secure the portion 204A of the bladder 204 in the gap 216. The portion 204A of the bladder 204 may form a seal between the base portion 201 and the cover portion 203. The bladder 204 may form a watertight and/or airtight seal between the base portion 201 and the cover portion 203. The portion 204A of the bladder 204 may prevent or inhibit liquid and/or gas from exiting the inner volume 210 through the gap 216.

The bladder 204 may separate a first portion 210A of the inner volume 210 from a second portion 210B of the inner volume 210. The bladder 204 and/or the support 220 may form a barrier between the first portion 210A of the inner volume 210 and the second portion 210B of the inner volume 210. The first portion 210A of the inner volume 210 may include a portion of the inner volume 210 between the bladder 204 and the first end 202A of the housing 202. The second portion 210B may include a portion of the inner volume 210 between the bladder 204 and the second end 202B of the housing 202. The support 220 and the spring 240 may be positioned in the second portion 210B of the inner volume 210.

Fluid (e.g., water) may enter the first portion 210A of the inner volume 210 through a fluid port 206 in the base portion 201 of the housing 202. The fluid port 206 may be positioned at the first end 202A of the housing 202. The fluid may enter the first portion 210A of the inner volume 210 at a pressure. The pressure of the fluid may apply a force to the bladder 204, and consequently, the support 220. When the force applied to the support 220 by the fluid is larger than the force applied by the support 220 by the spring 240, the support 220 may translate towards the second end 202B of the housing 202. The pressure of the fluid may force the bladder 204 against the support 220. When the support 220 translates towards the second end 202B of the housing 202, the bladder 204 may contract towards the second end 202B of the housing 202. Therefore, a volume of the first portion 210A of the inner volume 210 may increase and a volume of the second portion 210B of the inner volume 210 may decrease. When the volume of the second portion 210B of the inner volume 210 decreases air in the second portion 210B of the inner volume 210 may be compressed. Accordingly, the air in the second portion 210B of the inner volume 210 may act as a spring and apply a force (e.g., pressure) to the support 220 when the volume of the second portion 210B of the inner volume 210 decreases. The support 220 may translate towards the second end 202B of the housing 202 and the bladder 204 may contract towards the second end 202B of the housing 202 until the force applied to the support 220 by the spring 240 and/or air in the second portion 210B of the inner volume 210 is equal to the force applied to the support 220 by the pressure of the fluid.

The pressure of the fluid in the first portion 210A of the inner volume 210 may decrease. As the pressure of the fluid in the first portion 210A of the inner volume 210 decreases, the force applied to the support 220 by the pressure of the fluid may also decrease. Therefore, the force applied to the support 220 by the spring 240 may be larger than the force applied to the support 220 by the pressure of the fluid and the spring 240 may translate the support 220 towards the first end 202A of the housing 202. When the support 220 translates towards the first end 202A of the housing 202, the bladder 204 may expand towards the first end 202A of the housing 202. Therefore, the volume of the second portion 210B of the inner volume 210 may increase and the volume of the first portion 210A of the inner volume 210 may decrease. The accumulator 200 may be used as an expansion tank for the boiler 151. The accumulator 200 may be used to maintain or regulate a pressure of fluid (e.g., water) in the boiler 151 and/or the beverage dispensing machine 150.

The first end 222 of the support 220 may be curved or rounded. For example, the first end 222 of the support 220 may include a hemispherical shape. The support 220 and/or the bladder 204 may not block the fluid port 206. When the first end 222 of the support 220 and/or the bladder 204 contacts an inner wall 201A of the base portion 201 at the first end 202A of the housing 202, the support 220 and/or the bladder 204 may not prevent or inhibit fluid from entering and/or exiting the inner volume 210 of the housing 202 via the fluid port 206 and/or the pressure relief valve 214.

The support 220 may include plastic, metal, and/or any other rigid material.

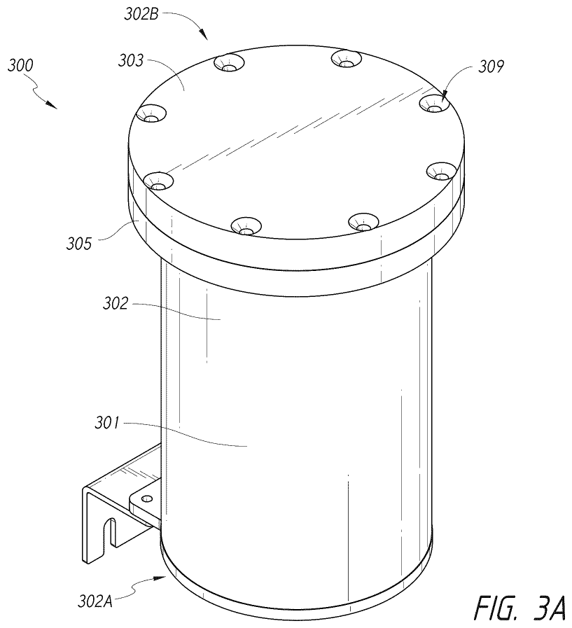

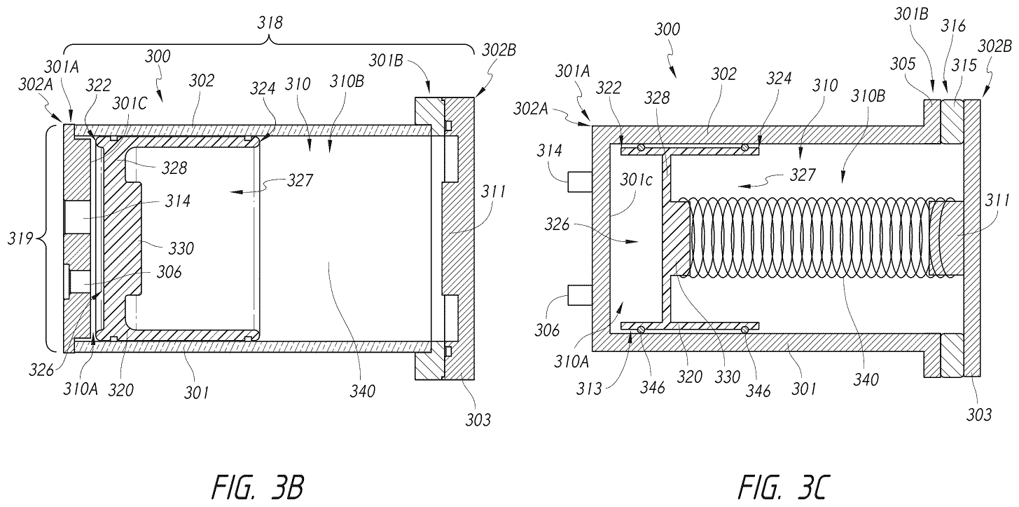

FIGS. 3A-3C show an embodiment of an accumulator 300. The accumulator 300 may include any of the features of the accumulator 200 except for the differences described with reference to FIG. 3A-3C. The accumulator 300 may include a mechanical accumulator. As shown in FIG. 3C, instead of a bladder, the accumulator 300 may include a piston 320 and a spring 340. The spring 340 may expand and/or contract to translate the piston 320 through an inner volume 310 of a housing 302 of the accumulator 300. When the piston 320 translates through the inner volume 310, a volume of a first portion 310A of the inner volume 310 may increase and/or decrease. The accumulator 300 may be used as an expansion tank for the boiler 151

As shown in FIG. 3A, the accumulator 300 may include a housing 302. The housing 302 may extend from a first end 302A to a second end 302B opposite the first end 302A. The housing 302 may include a base portion 301 and a cover portion 303. The cover portion 303 may be coupled to the base portion 301 to form the housing 302. The base portion 301 may extend from a first end 301A to a second end 301B. The first end 301A of the base portion 301 may be the first end 302A of the housing 302. The cover portion 303 may be coupled to the base portion 301 at the second end 301B of the base portion 301. The cover portion 303 may be positioned at the second end 302B of the housing 302.

As shown in FIGS. 3B and 3C, the housing 302 may include a pressure relief valve 314. The pressure relief valve 314 may be positioned on the base portion 301 at the first end 302A of the housing 302.

As shown in FIG. 3A, the base portion 301 may include a flange 305. The flange 305 may extend radially outward from the second end 301B of the base portion 301. The flange 305 and the cover portion 303 may include holes 309 extending through the flange 305 and the cover portion 303. Mechanical fasteners (e.g., bolts, screws, etc.) may be inserted through the holes 309 to secure the flange 305 and the cover portion 303 together and couple the base portion 301 to the cover portion 303. As shown in FIG. 3C, a seal 315 may be positioned in a gap 316 between the flange 305 and the cover portion 303. The seal 315 may form a watertight and/or airtight seal between the flange 305 of the base portion 301 and the cover portion 303. The seal 315 may prevent or inhibit liquid and/or gas from exiting the inner volume 310 through the gap 316.

The housing 302 may include a height 318 and a diameter 319, as shown in FIG. 3B. The height 318 of the housing 302 may include a distance of about 3.0 in, about 4.0 in, about 5.0 in, about 6 in, about 7.0 in, about 8.0 in, about 9.0 in, about 10.0 in, about 11.0 in, about 12.0 in, about 13.0 in, about 14.0 in, about 15.0 in, about 16.0 in, about 17.0 in, about 18.0 in, about 19.0 in, about 20.0 in, and/or any value between the aforementioned values. The diameter 319 of the housing 202 may include a distance of about 1.0 in, about 1.5 in, about 2.0 in, about 2.5 in, about 3.0 in, about 3.5 in, about 4.0 in, about 4.5 in, about 5.0 in, about 5.5 in, about 6.0 in, about 6.5 in, about 7.0 in, about 7.5 in, about 8.0 in, about 8.5 in, about 9.0 in, about 9.5 in, about 10.0 in, and/or any value between the aforementioned values.

As shown in FIGS. 3A-3C, the piston 320 may be positioned in the inner volume 310. The piston 320 may be configured to translate through the inner volume 310 between the first end 302A of the housing 302 and the second end 302B of the housing 302. The piston 320 may be positioned in the inner volume 310 so a first end 322 of the piston 320 faces the first end 302A of the housing 302 and/or a second end 324 of the piston 320 faces the second end 302B of the housing 302. The piston 320 may include stainless steel and/or any other rigid, food safe material.

The piston 320 may include a first recess 326 and a second recess 327. The first recess 326 may extend into the piston 320 from the first end 322 of the piston 320. The second recess 327 may extend into the piston 320 from the second end 324 of the piston 320. The piston 320 may include a base 328 between the first recess 326 and the second recess 327. The piston 320 may include a protrusion 330 positioned on the base 328. The protrusion 330 may be positioned in the second recess 327. The protrusion 330 may extend from the base 328 towards the second end 324 of piston 320. The first recess 326 may prevent or inhibit the piston 320 from blocking the fluid port 306 and/or the pressure relief valve 314 when the first end 322 of the piston 320 contacts an inner wall 301C of the base portion 301 at the first end 302A of the housing 302. Therefore, the piston 320 may not prevent or inhibit fluid from entering and/or exiting the inner volume 310 of the housing 302 via the fluid port 306 and/or the pressure relief valve 314.

As shown in FIG. 3C, the spring 340 may be positioned in the inner volume 310 of the housing 302. The spring 340 may be positioned between the piston 320 and the second end 302B of the housing 302. The spring 340 may be coupled to the piston 320. The spring 340 may extend into the second recess 327 in the piston 320. The spring 340 may be coupled to the protrusion 330.

As shown in FIGS. 3B and 3C, the cover portion 303 may include a protrusion 311. The protrusion 311 may be positioned in the inner volume 310 of the housing 302. The protrusion 311 may extend from the cover portion 303 into the inner volume 310. The protrusion 311 may extend from the second end 302B of the housing 302. As shown in FIG. 3C, the spring 340 may be coupled to the protrusion 311.

With reference to FIG. 3C, when the piston 320 translates towards the second end 302B of the housing 302 the spring 340 may compress. The spring 340 may apply a reaction force to the piston 320 in a direction towards the first end 302A of the housing 302. The spring 340 may prevent or inhibit the piston 320 from translating towards the second end 302B of the housing 302. When the piston 320 translates towards the first end 302A of the housing 302, the spring 340 may elongate. The reaction force applied to the piston 320 by the spring 340 in a direction towards the first end 302A of the housing 302 may decrease and/or the spring 340 may apply a reaction force to the piston 320 in a direction towards the second end 302B of the housing 302. The spring 340 may prevent or inhibit the piston 320 from translating towards the first end 302A of the housing 302. The spring 340 may be biased towards the first end 302A of the housing 302. Therefore, when no forces are applied to the piston 320, the spring 340 may position the piston 320 in the inner volume 310 at the first end 302A of the housing 302.

The piston 320 may separate a first portion 310A of the inner volume 310 from a second portion 310B of the inner volume 310. The piston 320 may form a barrier between the first portion 310A and the second portion 310B of the inner volume 310. The first portion 310A of the inner volume 310 may include a portion of the inner volume 310 between the piston 320 and the first end 302A of the housing 302. The second portion 310B may include a portion of the inner volume 210 between the piston 320 and the second end 302B of the housing 302. The spring 340 may be positioned in the second portion 310B of the inner volume 310.

The accumulator 300 may include one or more seals 346 positioned in a gap 313 between the piston 320 and the housing 302. The one or more seals 346 may be positioned circumferentially around the piston 320. The one or more seals 346 may create a watertight and/or airtight seal between the piston 320 and the housing 302. The one or more seals 346 may prevent or inhibit liquid and/or gas from moving from the first portion 310A of the inner volume 310 to the second portion 310B of the inner volume 310 through the gap 313. The one or more seals 346 may prevent or inhibit liquid and/or gas from moving from the second portion 310B of the inner volume 310 to the first portion 310A of the inner volume 310 through the gap 313. In some embodiments, the accumulator 300 may include one (1) seal 346, two (2) seals 346, three (3) seals 346, four (4) seals 346, five (5) seals 346, six (6) seals 346, seven (7) seals 346, eight (8) seals 346, nine (9) seals 346, and/or ten (10) seals 346.

Fluid (e.g., water) may enter the first portion 310A of the inner volume 310 through a fluid port 306 in the base portion 301 of the housing 302. The fluid port 306 may be positioned at the first end 302A of the housing 302. The fluid may enter the first portion 310A at a pressure. The pressure of the fluid may apply a force to the piston 320. When the force applied to the piston 320 by the fluid is larger than the force applied to the piston 320 by the spring, the piston 320 may translate towards the second end 302B of the housing 302. Therefore, a volume of the first portion 310A of the inner volume 310 may increase and a volume of the second portion 310B of the inner volume 310 may decrease. The piston 320 may translate towards the second end 302B of the housing 302 until the force applied to the piston 320 by the spring 340 is equal to the force applied to the piston 320 by the pressure of the fluid.

The pressure of the fluid in the first portion 310A of the inner volume 310 may decrease. As the pressure of the fluid in the first portion 310A of the inner volume 310 decreases, the force applied to the piston 320 by the pressure of the fluid may also decrease. Therefore, the force applied to the piston 320 by the spring 340 may be larger than the force applied to the piston 320 by the pressure of the fluid and the spring 340 may translate the piston 320 towards the first end 302A of the housing 302. When the piston 320 translates towards the first end 302A of the housing 302, the volume of the second portion 310B of the inner volume 310 may increase and the volume of the first portion 310A of the inner volume 310 may decrease. The accumulator 300 may be used as an expansion tank for the boiler 151. The accumulator 300 may be used to maintain or regulate a pressure of fluid (e.g., water) in the boiler 151.

The springs 240, 340 may include a spring rate. The spring rate may include a force required to compress and/or extend a spring by one inch. The spring rate of the springs 240, 340 may be selected so the accumulators 200, 300 maintain a pressure in the boiler 151 within an operating range of the boiler 151 and/or a coffee machine. In some embodiments, the spring rate of the springs 240, 340 may include about 100 pounds per inch (lbs./in), about 105 lbs./in, about 110 lbs./in, about 115 lbs./in, about 120 lbs./in, about 123 lbs./in, about 125 lbs./in, about 130 lbs./in, about 135 lbs./in, about 140 lbs./in, about 145 lbs./in, about 150 lbs./in, about 155 lbs./in, about 160 lbs./in, about 165 lbs./in, about 170 lbs./in, about 175 lbs./in, about 180 lbs./in, about 185 lbs./in, about 190 lbs./in, about 195 lbs./in, about 200 lbs./in, and/or any value between the aforementioned values. The springs 240, 340 may include a maximum load. The maximum load of a spring may include a force required to fully compress a spring. In some embodiments, the maximum load of the springs 240, 340 may include a force of about 300 lbs., about 310 lbs., about 320 lbs., about 330 lbs., about 340 lbs., about 350 lbs., about 360 lbs., about 370 lbs., about 380 lbs., about 390 lbs., about 400 lbs., about 410 lbs., about 420 lbs., about 430 lbs., about 440 lbs., about 450 lbs., about 460 lbs., about 470 lbs., about 480 lbs., about 490 lbs., about 500 lbs., about 510 lbs., about 520 lbs., about 530 lbs., about 540 lbs., about 550 lbs., about 560 lbs., about 570 lbs., about 580 lbs., about 590 lbs., about 600 lbs., and/or any value between the aforementioned values.

The springs 240, 340 may be preloaded so the springs 240, 340 apply a force to the support 220 and piston 320 when no fluid is in the inner volume 210, 310. Preloading the springs 240, 340 may increase a minimum pressure required to translate the support 220 and the piston 320 towards the second ends 202B, 302B of the housings 202, 302. Preloading the springs 240, 340 may increase the maximum load of the springs 240, 340. When the springs are preloaded, the maximum load of the springs 240, 340 may include a force of about 500 lbs., about 510 lbs., about 520 lbs., about 530 lbs., about 540 lbs., about 550 lbs., about 560 lbs., about 570 lbs., about 580 lbs., about 590 lbs., about 600 lbs., about 610 lbs., about 620 lbs., about 630 lbs., about 640 lbs., about 650 lbs., about 660 lbs., about 670 lbs., about 680 lbs., about 690 lbs., about 700 lbs., about 710 lbs., about 720 lbs., about 730 lbs., about 740 lbs., about 750 lbs., about 760 lbs., about 770 lbs., about 780 lbs., about 790 lbs., about 800 lbs., about 810 lbs., about 820 lbs., about 830 lbs., about 840 lbs., about 850 lbs., about 860 lbs., about 870 lbs., about 880 lbs., about 890 lbs., about 900 lbs., about 910 lbs., about 920 lbs., about 930 lbs., about 940 lbs., about 950 lbs., about 960 lbs., about 970 lbs., about 980 lbs., about 990 lbs., about 1000 lbs., about 1100 lbs., about 1200 lbs., about 1300 lbs., about 1400 lbs., about 1500 lbs., and/or any value between the aforementioned values

The cover portions 203, 303 may be decoupled from the base portions 201, 301 in order to remove the springs 240, 340. The springs 240, 340 may be replaced with different springs 240, 340 that include different spring rates and/or maximum loads in order to modify a pressure of the fluid in the accumulators 200, 300 required to compress the springs 240, 340.

### Certain Terminology

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### Summary

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of accumulators have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A beverage dispensing machine comprising:
a brew chamber;
a boiler configured to provide heated, pressurized water to the brew chamber; and
an accumulator comprising:
a housing with an inner volume;
a bladder positioned in the inner volume, wherein the bladder forms a barrier between a first portion of the inner volume and a second portion of the inner volume;
a support positioned in the second portion of the inner volume, wherein the bladder is positioned over the support; and
a spring positioned in the second portion of the inner volume,
wherein when a force is applied to the bladder by a fluid in the first portion of the inner volume, the spring expands and/or contracts in order to translate the support through the inner volume, and wherein the bladder is configured to expand and/or contract to modify a volume of the first portion of the inner volume when the support translates through the inner volume in order to regulate a pressure of the fluid in the boiler.

2. The beverage dispensing machine of claim 1, wherein the bladder comprises an elastic material.

3. The beverage dispensing machine of claim 1, wherein the support extends between a first end and a second end, and wherein the bladder is positioned over the first end of the support.

4. The beverage dispensing machine of claim 3, wherein the first end of the support is rounded.

5. The beverage dispensing machine of claim 3, wherein the support comprises a recess extending into the support from a second end.

6. The beverage dispensing machine of claim 5, wherein the spring is coupled to a protrusion in the recess of the support.

7. The beverage dispensing machine of claim 1, wherein the housing comprises a base portion and a cover portion, and wherein a portion of the bladder is positioned in a gap between the base portion and the cover portion to form a seal between the base portion and the cover portion.

8. A beverage dispensing machine comprising:
a brew chamber;
a boiler configured to provide heated, pressurized water to the brew chamber; and
an accumulator comprising:
a housing with an inner volume;
a piston positioned in the inner volume, wherein the piston forms a barrier between a first portion of the inner volume and a second portion of the inner volume; and
a spring positioned in the second portion of the inner volume,
wherein when a force is applied to the piston by a fluid in the first portion of the inner volume, the spring expands and/or contracts into order to translate the piston through the inner volume to modify a volume of the first portion of the inner volume and regulate a pressure of the fluid in the first portion of the inner volume.

9. The beverage dispensing machine of claim 8, wherein the piston extends between a first end and a second end, and wherein the first end of the piston faces the first portion of the inner volume.

10. The beverage dispensing machine of claim 9, wherein the piston comprises a first recess extending into the piston from the first end of the piston.

11. The beverage dispensing machine of claim 9, wherein the piston comprises a second recess extending into the piston from the second end of the piston.

12. The beverage dispensing machine of claim 11, wherein the spring is coupled to a protrusion in the second recess of the piston.

13. The beverage dispensing machine of claim 8, wherein the accumulator comprises one or more seals positioned around the piston in a gap between the piston and the housing.

14. An accumulator for a beverage dispensing machine comprising:
a housing with an inner volume;
a barrier positioned in the inner volume and configured to translate through the inner volume; and
a spring positioned in the inner volume and coupled to the barrier, wherein when a force is applied to the barrier by a fluid in a first portion of the inner volume, the spring expands and/or contracts to modify a volume of the first portion of the inner volume in order to regulate a pressure of the fluid in the first portion of the inner volume.

15. The accumulator of claim 14, wherein the barrier comprises a bladder and a support, wherein the support is configured to translate through the inner volume to expand and/or contract the bladder.

16. The accumulator of claim 14, wherein the barrier comprises a piston.

17. The accumulator of claim 14, wherein the housing comprises a base portion and a cover portion, wherein the base portion and the cover portion are configured to removably coupled together to form the housing.

18. The accumulator of claim 14, wherein the housing comprises a fluid valve.

19. The accumulator of claim 14, wherein the first portion of the inner volume is between a first end of the housing and the barrier, and the spring is positioned in a second portion of the inner volume between the barrier and a second end of the housing.

20. The accumulator of claim 14, wherein the accumulator is configured to be an expansion chamber of a boiler system of the beverage dispensing machine.
